(19) United States
(12) Patent Application Publication
(10) Pub. No.: US 2025/0346310 A1
(43) Pub. Date: Nov. 13, 2025

(54) VEHICLE WITH TRACK SYSTEM

(71) Applicant: Polaris Industries Inc., Medina, MN (US)

(72) Inventors: Zachary T. Kaczmarzyk, Circle Pines, MN (US); Daniel Strobach, Luck, WI (US); John Nutter, Stacy, MN (US); Scott D. Brinkman, Chisago City, MN (US); Kyle J. Dahlheimer, Marine on Saint Croix, MN (US)

(21) Appl. No.: 19/202,320

(22) Filed: May 8, 2025

Related U.S. Application Data
(60) Provisional application No. 63/645,521, filed on May 10, 2024.

(51) Int. Cl. B62D 55/065; B62D 55/10; B62D 55/108; B62D 55/125

(52) U.S. Cl. CPC B62D 55/0655; B62D 55/10; B62D 55/108; B62D 55/125

(57) ABSTRACT

A vehicle with four track systems, each track system comprising a track frame supporting a drive sprocket and a plurality of idler wheels, a looped track extends about and is engaged with the drive sprocket and idler wheels. Each drive sprocket is secured to driven hub of the vehicle. An anti-rotation device extends between each track frame and the suspension of the vehicle. The anti-rotation device has an elongatable and contractable portion and a spring portion to resist such elongation and/or contraction. A releasable portion attaches to engaged components of the elongatable and contractable portion to fix them in place with respect to one another. Upon reaching a load limit due to excessive rotation of the track system or other event, the releasable portion releases the engaged components thereby preventing or minimizing damage to the vehicle and/or track system. The releasable portion may be field reset, manually or may self-reset.

### CROSS REFERENCE TO RELATED APPLICATONS

This application claims the benefit of U.S. Provisional Application No. 63/645,521, filed May 10, 2024, and titled “VEHICLE WITH TRACK SYSTEM,” the disclosure of which is hereby incorporated herein by reference.

### BACKGROUND

Recreational and utility vehicles are used in various terrains and environments. Traditional tires perform well in many conditions but may struggle in particularly rugged or challenging terrain such as mud, snow, ice, or steep slopes. To enhance traction and maneuverability in such conditions, track systems have been developed as user swappable replacements for traditional wheels and tires on vehicles. These track systems typically consist of a set of tracks that replace the standard wheels, providing greater surface area contact with the ground and distributing the vehicle's weight more evenly. This results in improved traction, flotation, and stability, allowing vehicles to navigate through challenging terrain with greater ease.

### SUMMARY

The present disclosure describes a track system that can be used with vehicles including, but not limited to, side by side utility task vehicles having a frame, a suspension, and a drive system. In some embodiments, the vehicle may include wheels mounted to hub assemblies that can be swapped with the track systems allowing the vehicle to traverse a wider variety of off-road terrain and/or obstacles and provide better traction on surfaces such as mud and snow. Such track systems have a track frame that supports a drive sprocket that connects directly to the vehicle hub assemblies and rotates with the hub.

The track frame also supports several idler wheels, a looped track is driven by the drive sprocket and rides upon and is guided by the idler wheels. The idler wheels are generally positioned to provide a flattened lowered track path such that the track on the idler wheels has an extended lengthwise engagement with the ground surface providing an engagement surface many times that of conventional tires. Such increased engagement surfaces can increase loading and stresses on the vehicle framework, particularly the suspension systems, compared to normal tires. The load of the weight of the vehicle is transferred through the suspension systems, to the respective hub assemblies to the respective drive sprockets, to the track frames, to the respective idler wheels and through the respective track below the idler wheels to the ground. The flattened lower track path has a normal position that is parallel to the forward rearward axis of the vehicle. To allow the flattened lower track path to follow terrain and override obstacles, the track system is rotatable about the axis of the hub assembly to which it is attached. This rotation is limited by an anti-rotation device or mechanism extending between the track frame and the vehicle suspension that supports the hub assembly.

The anti-rotation mechanism may be configured as a spring loaded slider mechanism that allows limited and restrained rotation of the track system about the respective hub assembly, both clockwise and counterclockwise rotation. The slider elongates and retracts within limits defined by components of the slider. When a forward portion of the track engages an obstacle as the vehicle is moving forward, the track system rotates with increasing resistance with more rotation to allow the track and vehicle to ride over the obstacle. Thus, forces exerting a rotational force on the track system, such as the vehicle and track engaging an obstacle, provides a load path through the anti-rotation mechanism, and causes compressive and or tensile loading of the anti-rotation mechanism. Some of this loading will be readily absorbed by the coil spring of the mechanism.

The inventors have recognized that suspension failures are much more common with vehicles equipped with track systems than compared to such vehicles with conventional wheels and tires. Traversing difficult terrain or obstacles, particularly as the track system rotates, and the increased traction of the tracks engaging ground surfaces, can place excessive stresses on the vehicle suspension causing fracturing and other failures of the suspension components and/or the track system components potentially fully disabling the vehicle and requiring assistance to retrieve the vehicle and bring it to an alternate location for extensive repairs.

Even though the anti-rotation mechanism of track systems does not bear a substantial portion of the vehicle's weight, the inventors have recognized that incorporating a sacrificial component within the load path associated with rotation of the track system about the respective hub assembly can help prevent or reduce damage to the vehicle suspension and/or track system. The sacrificial component may be configured to fail under a predetermined loading condition, thereby absorbing excess force. Moreover, in embodiments, the sacrificial component may be readily replaced, for example in-the-field, putting the vehicle back into full operational condition after a component fail event.

The inventors have recognized that vehicle damage, and track system damage, in vehicles with track systems is largely attributable to the extraordinary forces on the track system, particularly terrain and/or obstacles causing excessive rotation or suddenness of rotation of the track systems on the vehicle and that providing an overload release capability associated with the anti-rotation device that releases upon occurrence of such excessive rotation or suddenness of rotation, greatly reduces the occurrence of damage to the vehicle and/or track system. Disclosed herein are solutions to providing an overload release as well as means for resetting the overload release. Such means may be readily done by the operator of the vehicle, such as in the field at the location of the occurrence. Such resetting may be accomplished by replacing a sacrificial component or a manual reset of the overload release. In embodiments, the overload release may be self-resetting.

In embodiments, an anti-rotation mechanism may have a release condition when it is overloaded to prevent or minimize damage to the vehicle suspension and/or the track systems. The anti-rotation mechanism is returnable to a non-released condition in the field readily by an operator. In embodiments, an audible signal is generated by the anti-rotation mechanism when the sacrificial component fails alerting the operator of a failure condition. In embodiments, the anti-rotation mechanism may be configured to continue to release an audible signal if the vehicle is continued to be operated after a failure event or release condition of the anti-rotation mechanism.

In embodiments, a track system for attachment to a hub assembly of a vehicle, wherein the vehicle has the hub assembly with a hub having an axis of rotation, the hub assembly supported by a suspension system, the track system having a track frame supporting a drive sprocket and a plurality of idler wheels, a looped track supported by the drive sprocket and a plurality of idler wheels, the drive sprocket attachable to the hub, the track frame, the plurality of idler wheels rotatable about the hub axis of rotation when the drive sprocket is installed on the hub; and an anti-rotation device for connecting the track frame to the vehicle frame, the anti-rotation device having an at rest normal length and being elongatable and/or contractable, the anti-rotation device having an elongatable and contractable portion having two components slidingly engaged, the elongatable and contractable portion connected to the track frame and connectable to the suspension system of the vehicle; an elongate spring configured to compress or extend under elongation and/or contraction of the elongatable and contractable portion; a frangible portion on the elongatable and contractable portion, the frangible portion securing the elongatable and contractable portion, the frangible portion releasable when loaded to a predetermined loading limit.

In embodiments, An overload protection system for a tracked vehicle, the system having an anti-rotation device providing a breakable link between the vehicle frame and the wheel-based track system, the breakable link configured to fail before damage to the vehicle frame or track system when the vehicle traverses an obstacle.

In embodiments, an overload protection system for a tracked vehicle, the tracked vehicle have a plurality of track systems, the overload protection system comprising a respective anti-rotation device for connection between a track frame of each track systems and the vehicle suspension, each anti-rotation system providing rotation resistance of the track system with respect to the vehicle when the track system encounters a change of terrain and/or obstacle, the anti-rotation device comprising an elongatable and contractable portion, a progressive resistance portion attached to the elongatable and contractable portion, and a releasable portion that releases when the anti-rotation device is subjected to a predetermined excessive loading, the release effecting a transition of the track system from a full functioning mode to a lesser functioning mode.

A track system for attachment to a hub assembly of a vehicle, wherein the vehicle has the hub assembly with a hub having an axis of rotation, the hub assembly supported by a suspension system, the track system having a track frame supporting a drive sprocket and a plurality of idler wheels, a looped track supported by the drive sprocket and a plurality of idler wheels, the drive sprocket attachable to the hub, the track frame, the plurality of idler wheels rotatable about the hub axis of rotation when the drive sprocket is installed on the hub; and an anti-rotation device for connecting the track frame to the vehicle frame, the anti-rotation device having an at rest normal length and being elongatable and contractable, the anti-rotation device having an elongatable and contractable portion having two components slidingly engaged, the elongatable and contractable portion connected to the track frame and connectable to the suspension system of the vehicle, the elongatable and contractable portion having a first maximum extension length;
an elongate spring configured to compress or extend under elongation and/or contraction of the elongatable and contractable portion; and a releasable portion configured to release in a predetermined overload condition that then provides a second maximum extension length of the elongatable and extension portion.

A kit or an assemblage of components for retail sale, the assemblage having one or more track systems; an anti-rotation device for each track system, each anti-rotation device having an releasable portion for overload conditions; instructions for installing the track systems; packaging containing the above.

In embodiments, A kit or an assemblage of a replacement anti-rotation device for a tracked vehicle, the assemblage having one or more anti-rotation devices having a releasable portion for when the track system to which the anti-rotation device experiences an overload condition; retention straps or devices to limit the separation of components when the track system to which the anti-rotation device is attached releases.

In embodiments, a kit or a retail assemblage of any combination of the track systems, anti-rotation devices, components, and accessories described herein, packaging and instructions.

A method for protecting the chassis and/or suspension of a tracked vehicle including providing a track system with a frame; securing the frame of the track system to the vehicle suspension with a link that is subjected to loading when the track system with a frame rotates about an axis of a drive hub to which it is attached, the link configured to fail when a load on the link exceeds a predetermined threshold.

In embodiments, when a sacrificial component fails under a loading condition, before the vehicle is damaged, an operator may be able to service the vehicle in the field, replacing the sacrificial component without requiring further assistance, and/or may be able to safely maneuver the vehicle to a final destination. Embodiments herein facilitate correcting an overload scenario in the field.

In embodiments, a failure mode operates to provide an extended length of the anti-rotation mechanism, allowing the anti-rotation mechanism to prevent rotation of the track assembly, and allowed continued operation of the vehicle in a less than full functional state.

In embodiments, the sacrificial component may be configured as a shear pin or shear bolt that is positioned within engaged components of the anti-rotation mechanism such that tensile or compressive loading of the anti-rotation mechanism causes a shear loading on the shear pin or shear bolt. In embodiments, the engaged components are linearly slidingly engaged components.

In some embodiments, the present disclosure describes a tracked vehicle with track systems as the ground engaging components, the tracked vehicle including a vehicle having a frame and a drive system, a track having an outward ground engaging surface opposite an interior surface, and a track frame. A plurality of wheels are supported by the track frame. The plurality of wheels are configured to engage with the interior surface of the track. The described vehicle drive system is operatively connected to the plurality of wheels to drive the track around the plurality of wheels. An anti-rotation device connects the track frame to the vehicle frame. The anti-rotation device includes a spring configured to compress or extend under load. The anti-rotation device further includes a frangible connection configured to break when a load on the anti-rotation device exceeds a predetermined overload threshold.

In some embodiments, an overload protection system for a tracked vehicle includes a vehicle having a frame and a drive system configured to drive a wheel-based track system for propelling the vehicle over a variety of terrain. The system further includes an anti-rotation device forming a breakable link between the vehicle frame and the wheel-based track system. The breakable link is configured to fail before the vehicle frame when the vehicle traverses an obstacle.

In some embodiments, a method for protecting a chassis of a tracked vehicle includes providing a vehicle with a frame; providing a track system with a frame; and securing the frame of the track system to the vehicle frame with a link configured to fail when a load on the link exceeds a predetermined threshold.

A feature and advantage of embodiments is an overload protection system that protects a vehicle from damage, particularly damage to the chassis that might render the vehicle inoperable. A feature and advantage of embodiments is a field serviceable or replaceable component that can be replaced when a track system is overloaded, allowing an operator to safely resume vehicle operation. A feature and advantage of embodiments is providing notification to an operator of an overload scenario before the vehicle frame, chassis, suspension, or track system, or other components suffer significant damage. A feature and advantage of embodiments is reducing fatigue on the vehicle frame and connection points.

A feature and advantage of embodiments is that track systems described herein may be utilized on straddle type all terrain vehicles as well as street legal four wheel drive vehicles. In embodiments, a pair of track systems as described herein may be utilized on the rear drive hubs of a vehicle with skis mounted on the front hub assemblies.

A feature and advantage of embodiments is that the releasable portion described herein effectively releases potential energy built up when a track system is forced to excessively rotate by the terrain on which it is operated. The release of potential energy occurs upon the release of the releaseable portion, for example, the fracturing of a frangible portion.

In embodiments a replacement anti-rotation mechanism is configured to replace existing anti-rotation mechanisms on track systems. The replacement anti-rotation mechanism having an overload release portion that includes spare replacement portions.

### BRIEF DESCRIPTION OF THE DRAWINGS

The disclosure can be understood in consideration of the following detailed description of various embodiments in connection with the accompanying drawings.

FIG. 1A is perspective view of a Prior Art utility task vehicle.

FIG. 1B is a perspective view of a forward suspension system and hub assembly of a Prior Art utility task vehicle.

FIG. 1C is a perspective view of a rearward suspension system and hub assembly of a Prior Art utility task vehicle.

FIG. 2A is a perspective view of a Utility Task Vehicle with track systems mounted thereon accord with embodiments.

FIG. 2B is a conceptual bottom view of a UTV with tires.

FIG. 2C is a conceptual bottom view of a UTV with track systems, suspension brackets, and anti-rotation mechanisms in accord with embodiments.

FIG. 3 is a perspective view of a track system in accord with embodiments.

FIG. 4 is a perspective view of the track system of FIG. 3 without the track.

FIG. 5A is a perspective view of bracketing and forward control arm for attachment of an anti-rotation mechanism in accord with embodiments.

FIG. 5B is a perspective view of the bracketing and control arm of FIG. 5A with the bracketing positioned on the control arm.

FIG. 5C is a perspective view of the bracketing of FIG. 5A with the bracketing attached.

FIG. 6A is a perspective view of bracketing and rear control arm for attachment of a anti-rotation mechanism in accord with embodiments.

FIG. 6B is a perspective view of the bracketing and control arm of FIG. 6A with the bracketing positioned on the control arm.

FIG. 6C is a perspective view of the bracketing of FIG. 6A with the bracketing attached.

FIG. 7 is a perspective and exploded view of an anti-rotation mechanism and connection point on a bracketing of a forward suspension of a Utility Task Vehicle.

FIG. 8 is a perspective view of a forward control arm that has a connection point for an anti-rotation mechanism without adding bracketing.

FIG. 9A is a perspective view of an anti-rotation device in accord with embodiments.

FIG. 9B is a cross-sectional view of a releasable portion of the anti-rotation device of FIG. 9A in accordance with embodiments.

FIG. 9C is a cross-sectional view of another releasable portion in accord with embodiments.

FIG. 10A is a perspective view of the inward side of the track system of FIG. 3 illustrating an anti-rotation mechanism connected to the track frame and positioning of the bracketing for attachment to the suspension.

FIG. 10B is a perspective view of the inward side of a track system with an anti-rotation mechanism connected to the suspension of a vehicle in accord with embodiments.

FIG. 10C is another perspective view of the track system and anti-rotation device of FIG. 10B.

FIG. 11A is another perspective view of the outward side of the track system and anti-rotation mechanism of FIG. 10B, with the track system rotated such as when encountering an obstacle.

FIG. 11B is a perspective view of the track system and anti-rotation mechanism of FIG. 11A with the shear pin fractured and the mechanism in a released state.

FIG. 12 is a perspective view of a anti-rotation device in accord with embodiments.

FIG. 13A is a schematic illustration of an anti-rotation mechanism on a tracked vehicle in accord with embodiments.

FIG. 13B is a schematic illustration of the anti-rotation mechanism of FIG. 13A in an elongated state.

FIG. 13C is a schematic illustration of the anti-rotation mechanism of FIG. 13A in an overload state where a frangible portion fractures.

FIG. 13D is a schematic illustration of the anti-rotation mechanism of FIG. 13C with separation of components of the anti-rotation mechanism after fracturing of the frangible portion.

FIG. 13E is a schematic illustration of the anti-rotation mechanism of FIG. 13D with the separated components reengaged.

FIG. 13F is a schematic illustration of the anti-rotation mechanism of FIG. 13E with a replacement frangible portion secured to the reengaged components putting the vehicle back into a full operational state.

FIG. 14 is a conceptual diagrammatic view of a retail assemblage in accord with embodiments.

FIG. 15 is a conceptual diagrammatic view of a retail assemblage in accord with embodiments.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

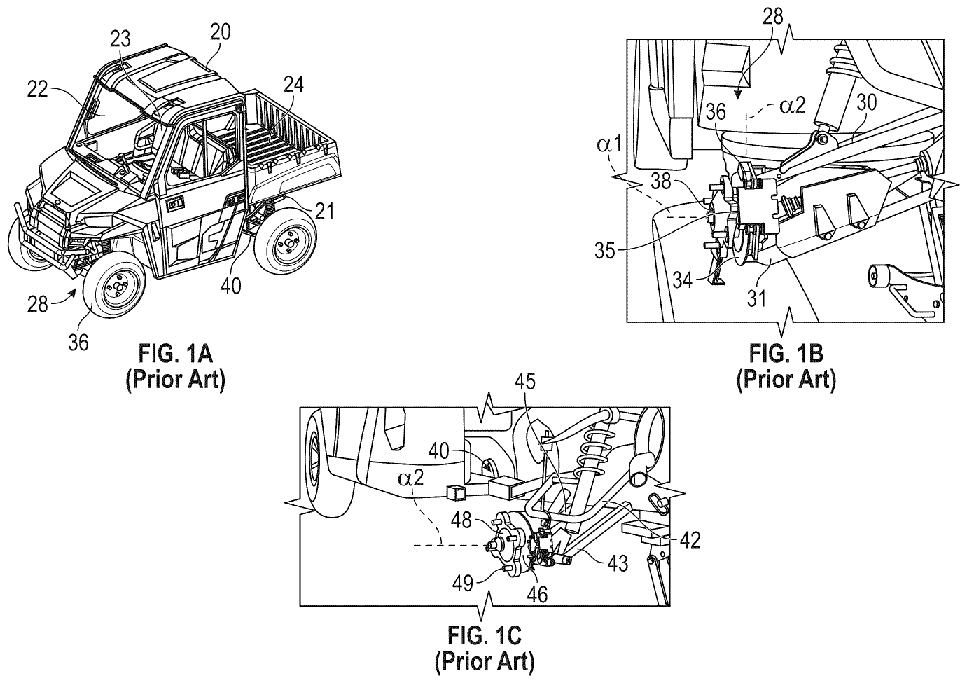

Referring to FIGS. 1A, 1B, and 1C, a conventional Prior Art Utility Task Vehicle (UTV) 20 is illustrated and generally has a frame 21, a passenger compartment 22 with seating 23, and a tiltable bed 24. The frame connects to forward suspension systems 28, each having an upper control arm 30, and lower forward control arm 31, that both connect to and support a hub assembly 34. FIG. 1B depicts the forward suspension system 28 in further detail. The forward hub assembly 34 having a hub 35 and a brake assembly 47 with projecting studs 38. The hub 35 for connecting to ground engaging components, for example the wheels with tires 36 or track systems such as described below. The forward hub rotatable about a forward hub axis α1 and is driven by the drive shaft 39. The hub assembly pivotally rotatable about a vertical axis α2 providing the vehicle steering function.

The vehicle frame 20 further supports rear suspension systems 40, each including rear upper control arms 42, and rear lower control arms 43. The rear upper control arms 42 and rear lower control arms 43 connect to and support rear hub assembly 46 which includes a brake assembly 47, and rear hub 48 with projecting studs 49. The rear hub for receiving the wheels with tires 36 or track systems, and being rotatable by way of drive shaft 45 about axis α2.

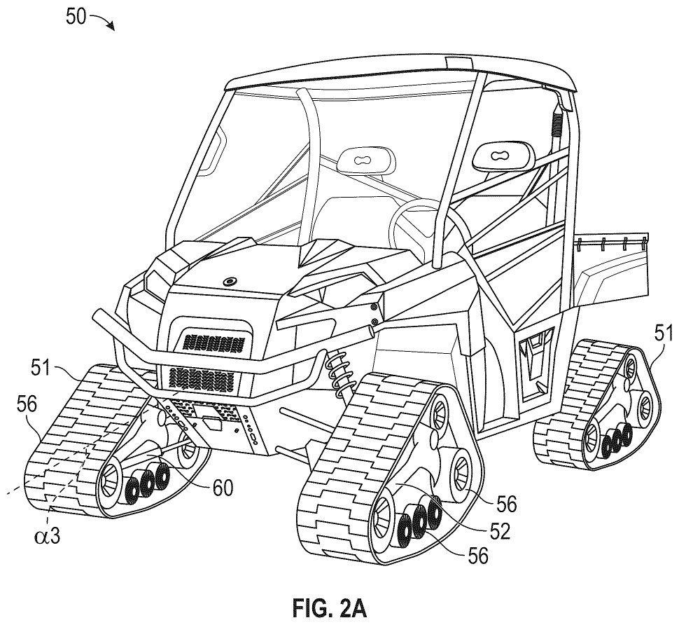

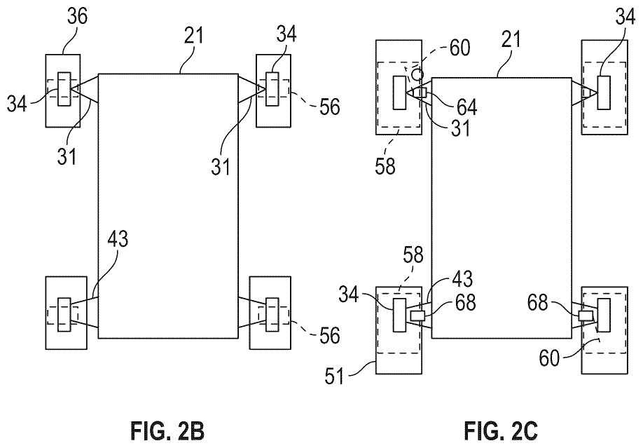

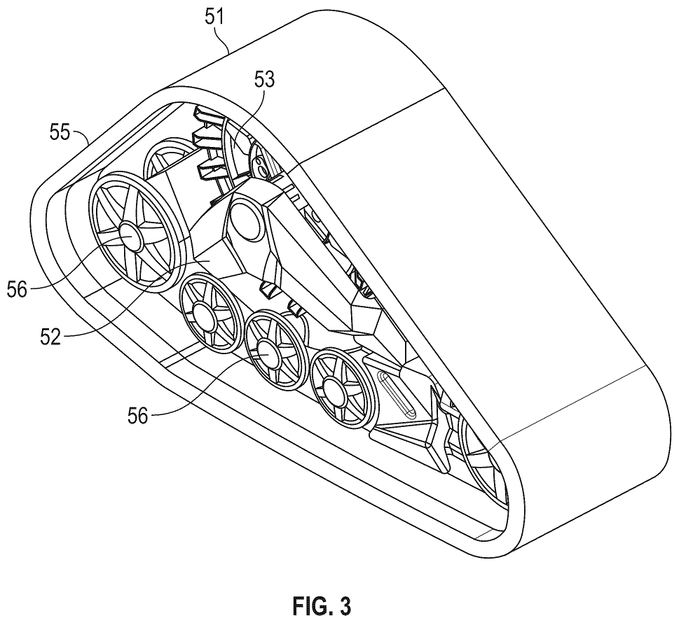

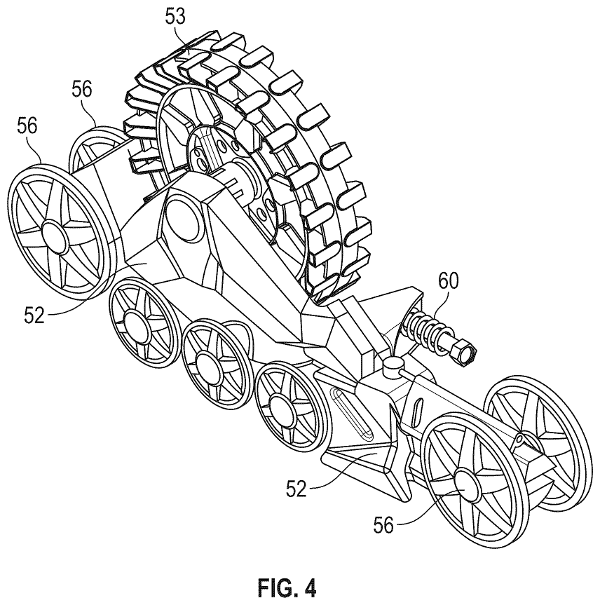

Referring to FIG. 2A, a UTV 50 with track systems 51 is illustrated. Also referring to FIGS. 3, 4, and 10A, further details of the track systems 51 are illustrated. Each track system has a track frame 52, rotatably supporting a drive sprocket 53, and rotatably supporting idler wheels 56. The drive sprocket and idler wheels supporting the track 55. The track systems are mounted to the UTV primarily by way of the drive sprockets 53 being secured to the hubs 35, same way as the wheels are secured to the hubs, by way of the projecting studs 38 extending from the hubs through the apertures 57 in the drive sprocket and with nuts secured on the studs. The track systems 51 are also connected to the UTV by way of anti-rotation mechanisms 60, described in detail below, that extend from or between the track frame and the respective suspension system.

The weight of the UTV, that is, the load path, is carried through the hub, drive sprocket, track frame, idler wheels, through the track below the idler wheels to the ground. When the hubs are driven and rotated by the UTV engine, the drive sprocket is rotated and the anti-rotation mechanism resists the torque forces of the drive sprocket acting on the balance of the track system, to prevent rotation of the track system keeping the idler wheels in a ground engaging position below the drive sprocket. As described further below, the anti-rotation mechanism is retractable and extendable lengthwise and a coil spring resists and dampens such retraction and extension motion. See U.S. Pat. Nos. 7,870,914; 8955925; 9033430; and 10137948 for further embodiments and componentry of track systems. Said patents are incorporated herein by reference for all purposes.

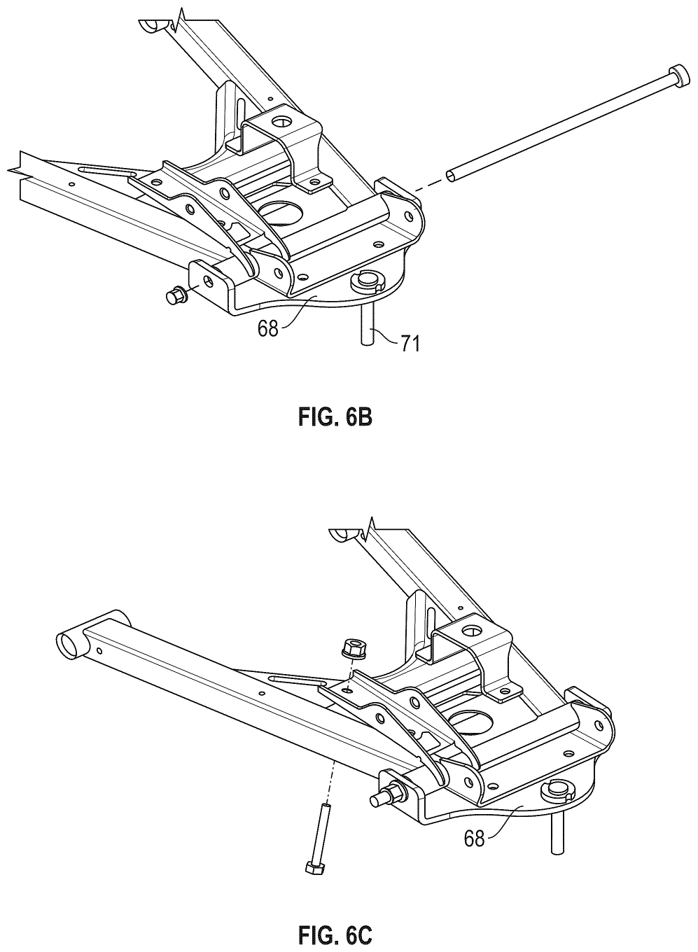

Referring to FIGS. 2B and 2C, bottom conceptual views, from the ground upward, illustrate distinctions between a UTV with wheels and tires, see FIG. 2B, and a UTV adapted for and with track systems 51, see FIG. 2C. In the bottom views, the hub assemblies are connected to and supported by the lower forward control arms 31 and rear lower control arms 43. FIGS. 2B and 2C compare the ground engagement area 58 of the tires 36 to the ground engagement area 58 of the track systems. The anti-rotation mechanisms 60 providing a connection between the track assemblies and UTV suspension are shown conceptually by dashed lines and extend forwardly and rearwardly. Referring to FIGS. 2C and 5A-6C, forward bracketing 64, and represented by rectangles in FIG. 2C, clamp or otherwise are securely attached to lower forward control arms 31 and provide a connection tab 65 that receives a pin or bolt 66. Rear bracketing 68, similarly is conformingly configured for rear lower control arms 43, are secured thereto, and provide a tab 69 for a pin or bolt 71.

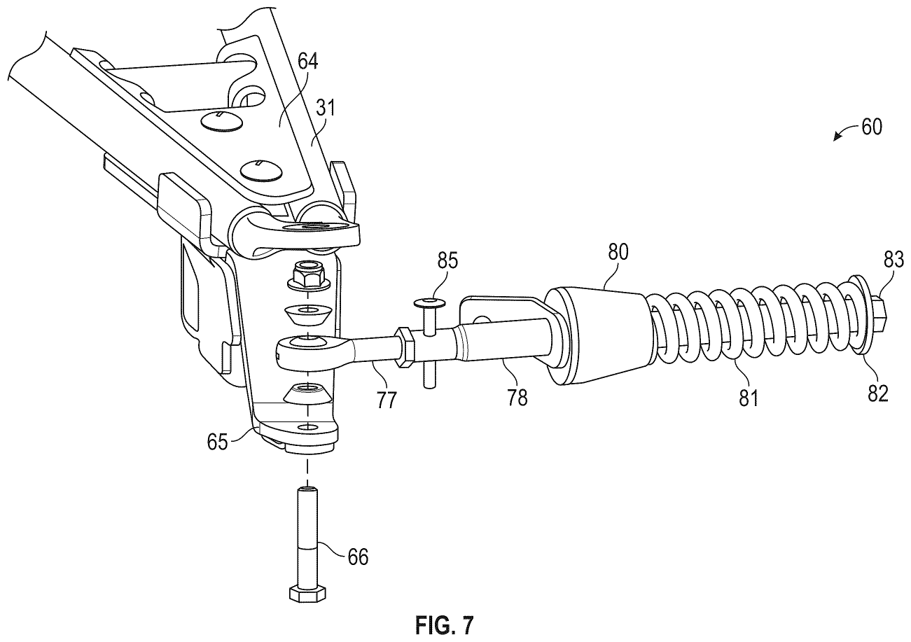

Referring to FIG. 7, an embodiment of an anti-rotation mechanism 60 is depicted as well as the components of the connection 74. In embodiments, the anti-rotation mechanism has a main shaft 77, which may be configured as a tie rod, that is slidingly engaged within a tubular shaft 78. The tubular shaft extending through and slidingly engaged with a bushing 80. A coil spring 81 positioned on the tubular shaft and may be connected to the bushing 80 and to the end of the tubular shaft 78 by attachment piece 82 and screw 83. The tubular shaft 78 and main shaft 77 may be locked in a non-sliding relationship by a frangible pin 85 that extends through cooperating holes in both components. The tubular shaft and main shaft may comprise steel or other metals. In other embodiments, other materials may be utilized such as rigid polymers. As described below, the anti-rotation mechanism may be secured to the track system, the track frame 52, at the bushing 80. In embodiments, the bolts 66 that secure the main shaft 77 to the forward bracketing 64 and thereby the forward suspension system 28, are in the load pathway when there is a rotational force applied to the track system such as when the UTV encounters an obstacle and the track climbs over the obstacle. Loading on the anti-rotation mechanism transfers through the bolts 66, that is, they are in the load pathway, said bolts may be selected and configured as frangible members, breaking under predetermined load levels, described in more detail below. Said bolts may also be configured as pins or other shapes. The bolt or pin may be configured or selected to provide an audible indicator when the fracture event occurs. Such an indication may be a loud shot sound alerting the operator to a release event.

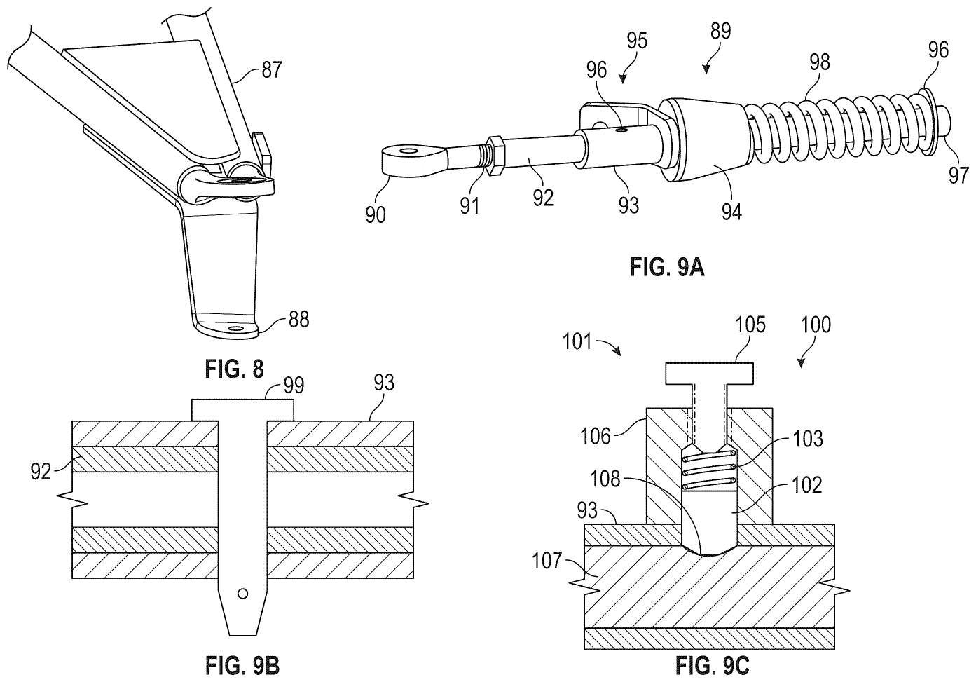

Rather than providing bracketing for attachment of the anti-rotation devices to the suspension, replacement control arms 87 such as illustrated in FIG. 8 may be provided. Such control arms may be overall strengthened compared to original control arms and also have the tab 88 as an attachment point of the anti-rotation device.

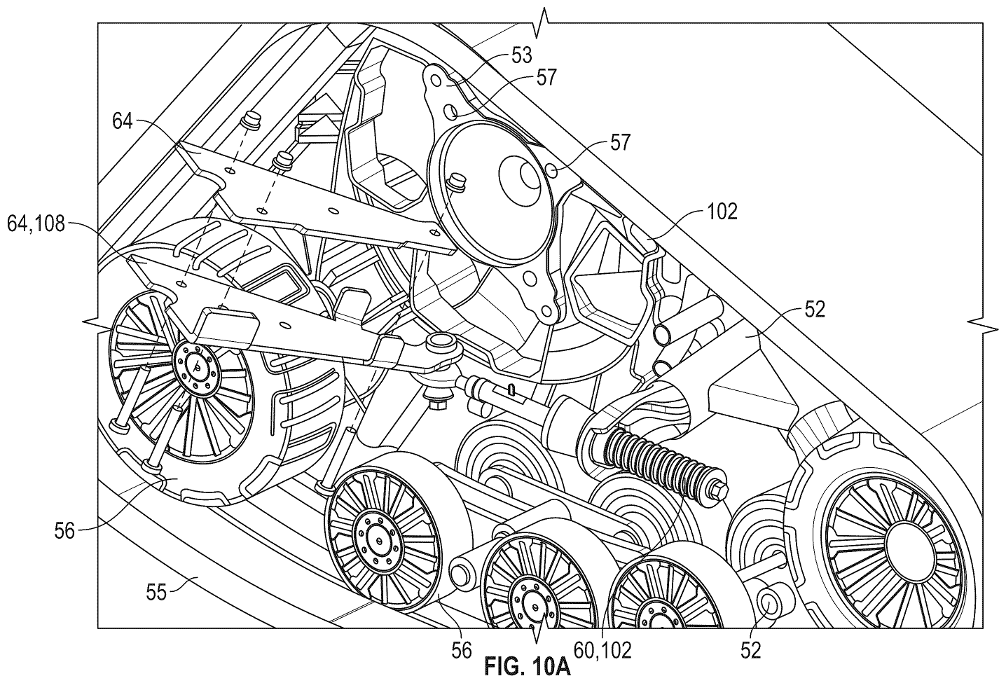

Referring to FIG. 9A, in embodiments, an anti-rotation device 89 has a tie rod 90 with a threaded portion 91 that engages an inner sliding member 92 configured as a first tubular portion having internal threads, not shown. The length of the anti-rotation device, measured between the attachment positions to the track frame and suspension, may thus be adjusted during installation. The inner sliding member is slidingly engaged with an outer sleeve member 93, configured as a second tubular portion, that is slidingly engaged with the bushing 94 that attaches to and is fixed to the track frame. The sleeve member may then extend to an end with a spring retention flange 97 secured thereto and with a coil spring 98 captured between the bushing 94 and the spring retention flange 97. The inner sliding member and outer sleeve member comprising a releasable portion 95. An aperture 96 is positioned on the outer sleeve member for receiving a frangible pin 99, for example, as shown in FIG. 9B. The frangible pin 99 being a shear pin that secures and linearly fixes the inner sliding member to the outer sleeve member. The shear pin may be one of an assortment of shear pins provided that have different shear thresholds, that is, that will fail at different loading levels such that an installer or operator may select the release load level of the shear pin.

Referring to FIG. 9C, rather than having an insertable and removable pin, in embodiments, a detent mechanism 100 may be utilized to provide a releasable portion 101. The detent mechanism having a plunger 102, a spring 103, a threaded adjustment screw 105, and a threaded base 106 secured, such as by welding, to the outer sleeve member 93. The inner sliding member 107 may have a depression or recess 108 which may extend around the circumference of the sliding member. The force of the plunger into the recess provides the adjustable release level of loading between the ends of the anti-rotation device 89. When due to rotation of the track system, the anti-rotation device is elongated, based on the anchor locations of the tie rod end and the attachment to the track frame, the spring is compressed. When a level of loading is reached that is the release level of the detent the inner sliding member is released from the outer sleeve member and the length of the anti-rotation device then further extends providing some additional rotation to the track wheels. In this embodiment of the releaseable portion, there is not a replaceable member, only a resettable member. In embodiments, when the rotation of the track system returns to a normal position, that is, parallel to the axis α3 of the vehicle, the releaseable portion may self-reset.

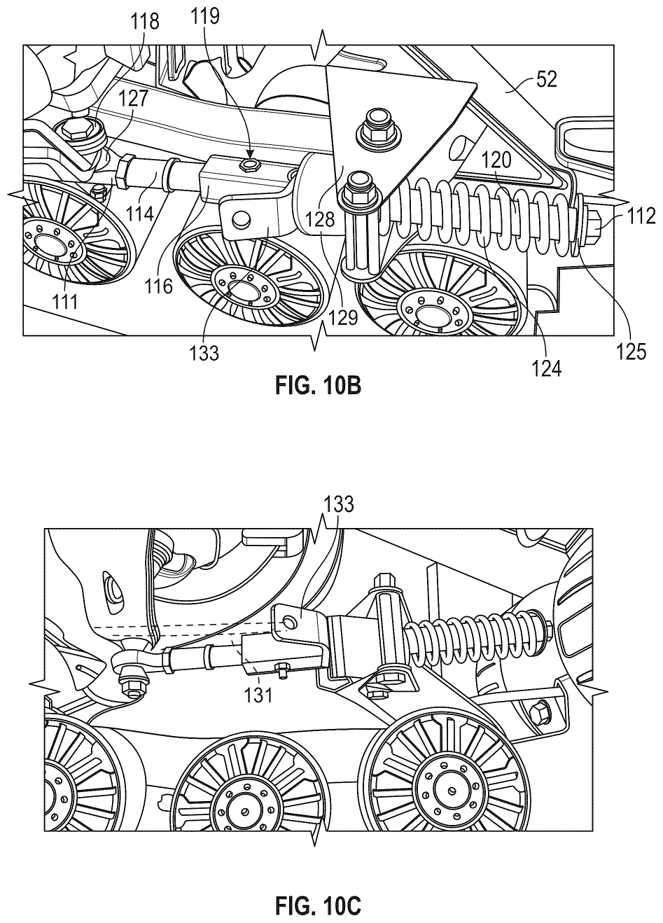

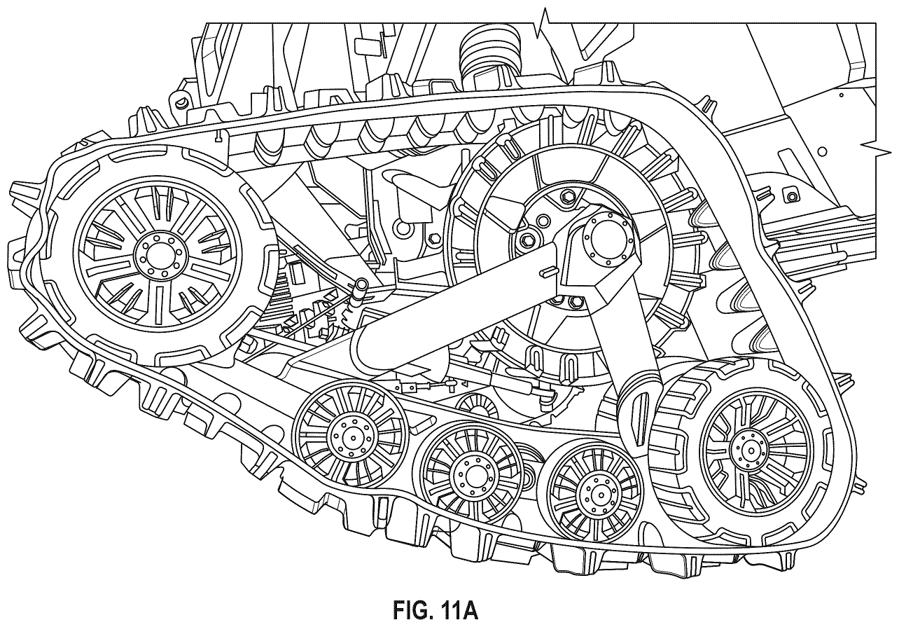

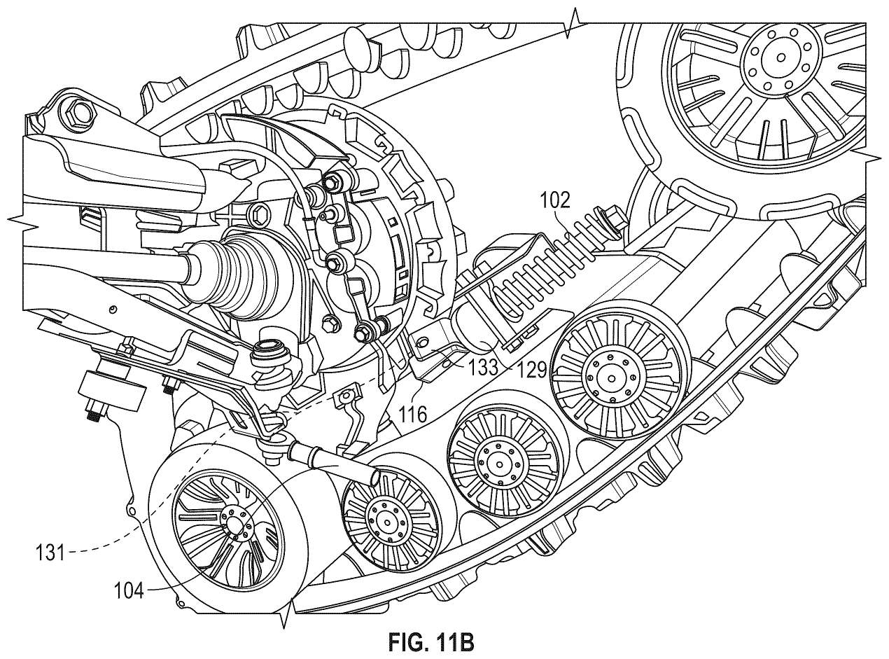

Referring to FIGS. 10A-11B, an anti-rotation mechanism 112 comprises a main shaft 114 connecting to the UTV at bracketing at an end 111 of the main shaft 114. The main shaft extends into a tubular portion 116 and is fastened thereto by a frangible pin 118 119. Tubular portion 116 is fixed to distal shaft 120 upon which the coil spring 124 is seated. Distal shaft 120 has an end flange 125 that retains the distal end of the coil spring 124. When the track system is rotated as depicted in FIG. 11A, the rotation causes a tensile load on the anti-rotation device causing compression of the coil spring 124 and elongation of an elongatable and contractable portion, the portion between the attachment 127 to the bracketing and the attachment 128 to the track shaft, such as at the bushing 129. When the load is over a predetermined level set by selection of a frangible pin with desired fracture characteristics, such as caused by a continuing rotation force on the track system, the pin fractures releasing the main shaft 104 from the tubular portion 116 as shown in FIG. 11B. The anti-rotation mechanism 112 has separated. In embodiments, strapping 131, cabling, linking or other means may be provided between the UTV and track frame that even after a fracture event of a frangible pin, the rotation of the track system is still limited. In such a status the track system will have lost its capability to be biased by the coil spring to a position parallel to the forward rearward axis of the vehicle. The tab 133 positioned on the anti-rotation device at the bushing may be used, for example, to attach such a strapping 131. The tab may also be utilized to connect a steering link or strap to limit the steering range.

Referring to FIG. 12, an embodiment of an anti-rotation mechanism 202, has a main shaft 204 that connects to the suspension of the vehicle, such as at bracketing described above, or may attach to a track frame mount. The main shaft is slidingly engaged with a tubular shaft 205 that extends through flange 210 and is slidingly movable therethrough. Movement of the tubular shaft with respect to the flange is resisted by the coil spring 216. The flange may be connected to the track frame or UTV. A frangible pin 220 is in the load path of the anti-rotation mechanism 112, such that a loading beyond a preselected fracture level, typically caused by sudden or over rotation of the track system, causes shearing of the pin, thereby release of the inner main shaft position fixation from the tubular shaft allowing the inner shaft to slide within the tubular shaft causing elongation or contraction of the anti-rotation mechanism. In embodiments, the tubular shaft has one or more guide slots 224 that guide projections 225 translate within. The guide slots have stops 226, 228 at opposing ends stop the guide projections to limit further elongation or contraction after a failure event of the frangible pin 220. Such guide pins in guide slot may then keep the anti-rotation mechanism in a functional assembled released position. An operator may then position the track system in a rotational position to realign the respective apertures of the main shaft and tubular shaft to allow insertion of a replacement pin. Main shaft 204 may have threading, not shown, to connect to a female threaded portion of a tie coupling, not shown, for attachment to the suspension.

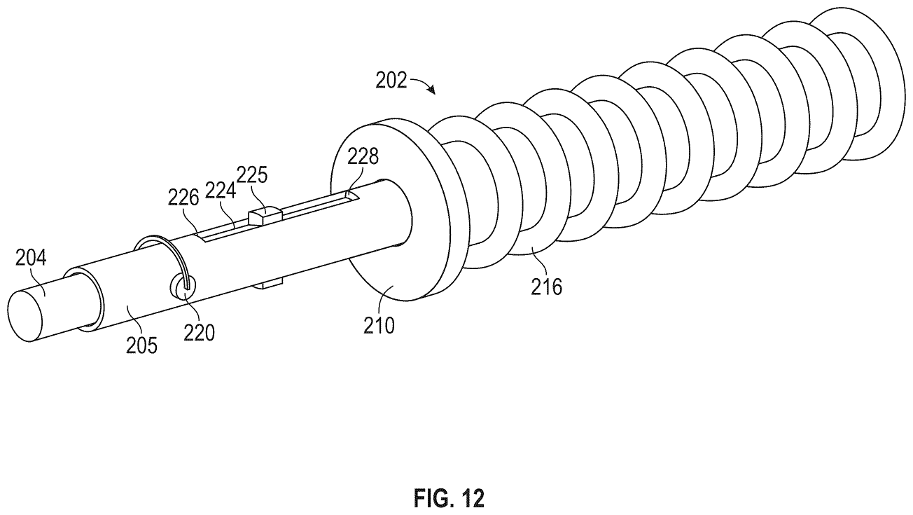

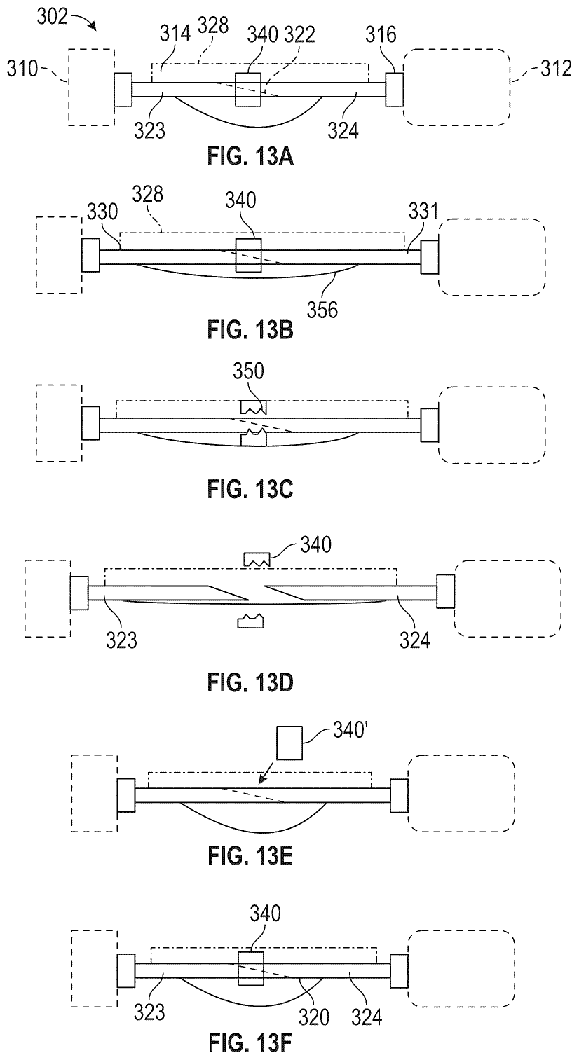

Referring to FIGS. 13A-13E, the functionality of embodiments and the cooperative interrelationship of components/portions of the anti-rotation device 302 or mechanism, the track system 310, and the vehicle 312 is illustrated in schematic fashion.

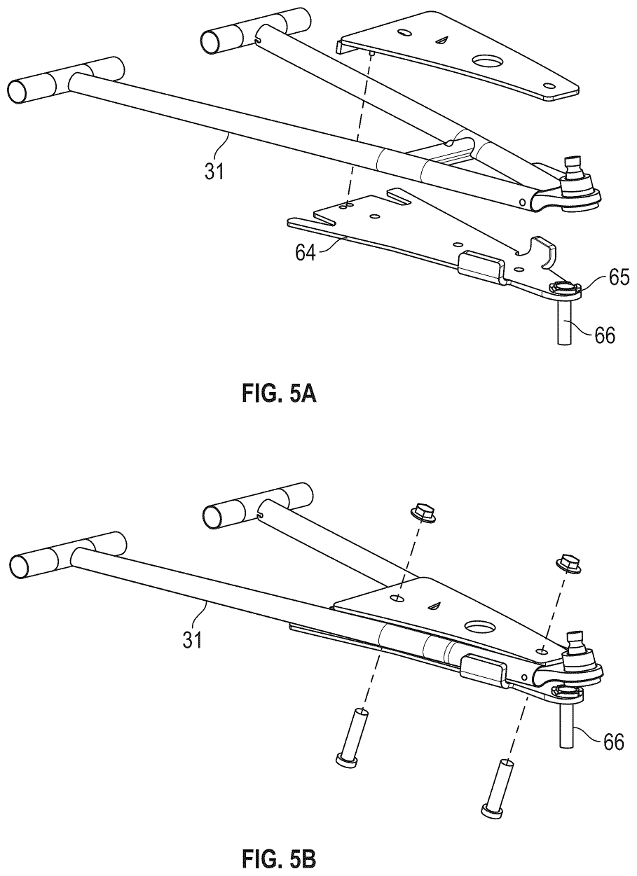

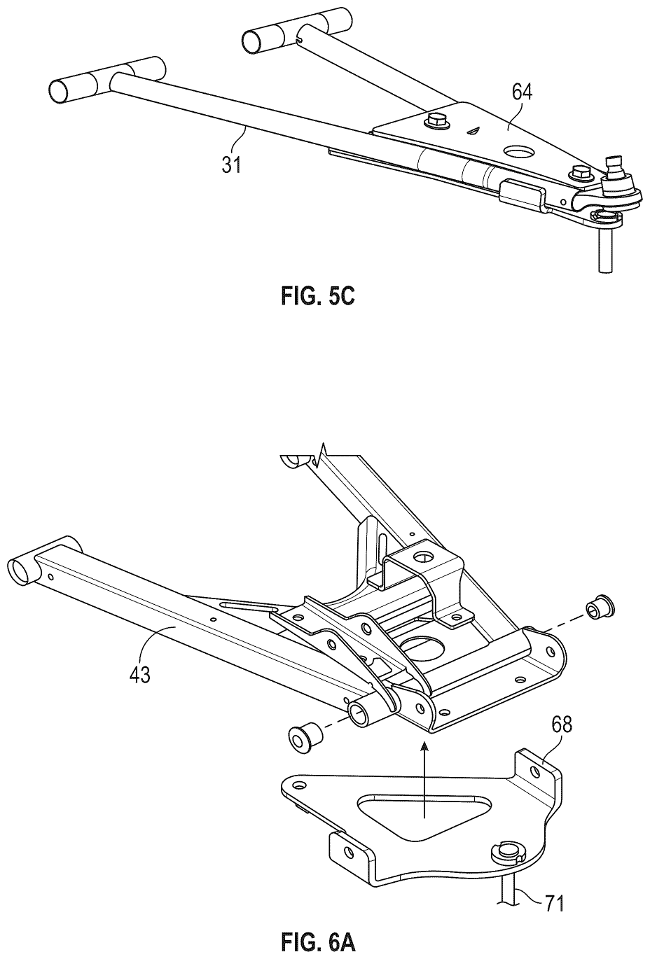

The anti-rotation device 302 has integrated therewith or associated therewith attachment means 314 for connection to the track system 310. Such attachment means may be brackets, clamps, fasteners, straps, hooks, and/or welded connections, or the like. In embodiments, the attachment means secures the anti-rotation to the track frame. Attachment means 316 for connection of the anti-rotation device to the vehicle may comprise bracketing as illustrated in FIGS. 5A-7, or fasteners, straps, or other means known to those in the art. In embodiments, the anti-rotation device may be connected to the suspension system of the vehicle, for example swing arms, as depicted in FIGS. 5A-9B. The anti-rotation device 302 comprises an elongatable and contractable portion 320 extendable between the which may comprise telescoping rigid members, sliding rigid links or linkages, pivotal connections of rigid members, deformable geometric structures of rigid and/or resilient materials. The elongatable and contractable portion 320 and components thereof may comprise metal, polymers, composite materials. The dashed line of juncture 322 indicates that in embodiments, the elongate and contractable portion may have two or more distinct separable components 323, 324.

In embodiments, the anti-rotation device may have a spring portion 328 as a component for providing resistance to elongation and/or compression of the elongatable and contractable portion 320. The spring portion may be a coiled metal spring, or other configurations of metal springs, or an elastomeric member formed of a polymer for example. The spring portion may have opposing ends 330, 331 that are attached to the elongatable and contractable portion or the ends may be attached to the attachment means 314, 316. In embodiments, the spring portion 328 and the elongatable and contractable portion 320 may be integrated together or otherwise combined. That is, the elongation and/or contraction of the structure comprising the elongation and contractable portion may have inherent resilience and resistance to such elongation and/or contraction. Such structures may be formed of polymers and/or metals.

In embodiments, the anti-rotation device may have a frangible portion 340 that may be configured as a frangible pin, a shear pin or bolt, or other component that can change transform one state to another state under loading, for example, a unitary state, to a fractured and separated state. In embodiments, the frangible portion 340 secures together the components 323, 324 of the elongatable and contractable portion 320. In embodiments, the transformation from one state to another state may be a yielding of the component such that it does not separate but permanently elongates.

The frangible portion may be selected from a set of frangible portions that have different loading limits where the transformation occurs. In embodiments, the frangible portion is readily replaceable on the elongatable and contractable portion 320, as illustrated in FIGS. 7, 9A, 9B, and 12. In such embodiments, the loading on the frangible portion is a shear loading. In other embodiments the loading may be a tensile or compressive loading. In embodiments, the frangible portion may be integrated with or unitary with the spring portion 328 and/or with the elongatable and contractable portion 320. For example, a metal spring may have a fracture limit that may be selected to provide the fracturing at a targeted loading level. Or an elastomeric member similarly may have a fracture limit at a level of loading or expansion that may allow selection of an elastomeric member to facilitate fracture as a desired/specified loading limit or elongation limit. Spare frangible portions may be carried in the vehicle for field replacement in the event of change of state such as a fracture.

In embodiments, the anti-rotation device may comprise a retention means 356 for retaining the separate components of the elongatable and contractable portion 320 in a separated but connected state. In an embodiment, such a retention means may be a strap or cable connected to and extending between the separate components 323, 324 of the elongatable and contractable portion 320, or other linkage. FIG. 12 shows an embodiment of a retention means comprising guide slots 224 and cooperating guide projections 225 in a telescoping elongatable and contractable portion.

Continuing to refer to FIGS. 13A-13F, in embodiments, the anti-rotation device 302 may comprise a noise generating means 350 for alerting the operator of the vehicle of a separation of the components 323, 324 of the elongatable and contractable portion or a change of state of the frangible portion 340, for example a fracturing of a shear pin. The noise of the noise generating means may occur upon the change of state and/or during operation of the vehicle after the change of state. The noise generating means may be provided by selecting a frangible portion that upon fracturing produces a loud noise. The noise generating means may be provided by metal component clanging together, for example. FIG. 12 illustrates a anti-rotation device where after separation, the interaction of the telescoping main shaft 204 and tubular shaft 205 may generate noise as they are moved with respect to one another.

FIG. 13A illustrates the anti-rotation device in a normal state, such as when the vehicle is not being operated or when the vehicle is operated on level terrain with no obstructions engaging the track system. FIG. 13B depicts a state of the anti-rotation device where the track system has engaged an obstacle, for example, that causes a partial rotation of the track system (excluding the drive sprocket), the rotation resisted by the spring portion 328. FIG. 13C illustrates a change of state event of the frangible portion 340 when a loading reached a targeted limit such as be over rotating the track system beyond a rotation limit, or by sudden rotation such a striking an obstacle to exceed a loading limit of the frangible portion. Loading on the frangible portion that exceeds the loading limit may be provided by the spring portion. FIG. 13D represents a release event of the components of the elongatable and contractable portion where they separate due to the fracturing of the frangible portion 340. The retention means 356 may retain the components 323, 324 of the elongatable and contractable portion in a close proximity state and also may prevent further or excessive rotation of the track system (excluding the drive sprocket). FIG. 13E represents a reconnection of the components 323, 324 of the elongatable and contractable portion and the installation of a replacement frangible portion 340′. Such a replacement may be performed, for example, in the field after a release event. FIG. 13F depicts the anti-rotation device in a full operative state with the components 323, 324 of the elongatable and contractable portion 320 secured together by the replacement frangible portion 340′.

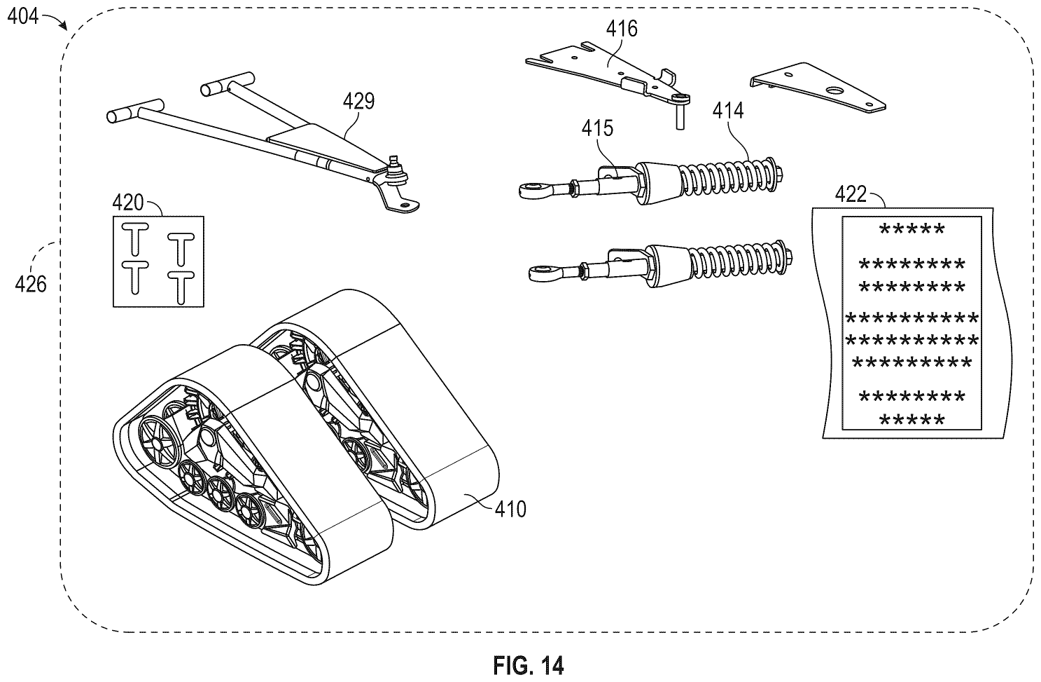

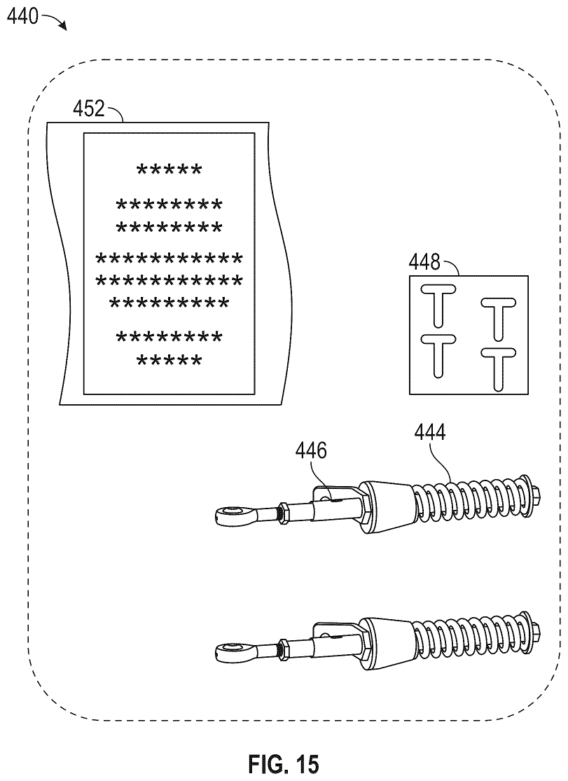

Referring to FIG. 14, a kit or a retail assemblage 404 comprises track systems 410 as described herein, anti-rotation devices 414 with overload release portions 415, bracketing 416, replacement sacrificial components 420, along with installation instructions and operational instructions 422 for utilizing same, all in suitable packaging 426. In embodiments, rather than including bracketing to attach the anti-rotation devices to the respective suspensions, replacement control arms 429 may be provided with attachment points for the anti-rotation devices.

In embodiments, for vehicles with existing track systems that do not have overload release capabilities, a kit or a retail assemblage 440 comprising replacement anti-rotation devices 444 with the overload releasable portion 446 and replacement sacrificial members 448 if the particular releasable portion utilizes such. Written instructions 452 may also be included. In some embodiments, some or all of the components of the disclosed systems and devices are provided as a kit, complete with instructions 422, 452 for use. The instructions are provided on a tangible, non-transitory medium, and may be physically included with the kits such as on a printed document (depicted), compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media may be local or accessible over the internet, for example by way of a bar code or QR-code, provided with the assemblage. The instructions may be complete on a single medium, or divided among two or more media. For example, some of the instructions may be written on a paper document that instruct the user to access one or more of the steps of the method over the internet, the internet-accessible steps being stored on a computer-readable medium or media. The instructions may embody the techniques and methods depicted or described herein using text, photos, videos, or a combination thereof to instruct and guide the user. The instructions may be in the form of written words, figures, photos, video presentations, or a combination thereof to instruct and guide the user.

The anti-rotation devices and other components disclosed herein are particularly suited for UTV's and ATV's but are also applicable to any vehicle that has wheels with tires on drive hubs. Such vehicles, particularly four-wheel drive passenger trucks may advantageously utilize the apparatuses and component disclosed herein.

The following clauses illustrate example subject matter described herein.
Clause 1: A track system for attachment to a hub assembly of a vehicle, wherein the vehicle has the hub assembly with a hub having an axis of rotation, the hub assembly supported by a suspension system, the track system having: a track frame supporting a drive sprocket and a plurality of idler wheels, a looped track supported by the drive sprocket and a plurality of idler wheels, the drive sprocket attachable to the hub, the track frame, the plurality of idler wheels rotatable about the hub axis of rotation when the drive sprocket is installed on the hub; and an anti-rotation device for connecting the track frame to the vehicle frame, the anti-rotation device having an at rest normal length and being elongatable and/or contractable, the anti-rotation device having: an elongatable and contractable portion having two components slidingly engaged, the elongatable and contractable portion connected to the track frame and connectable to the suspension system of the vehicle; an elongate spring configured to compress or extend under elongation and/or contraction of the elongatable and contractable portion; a frangible portion on the elongatable and contractable portion, the frangible portion securing the elongatable and contractable portion, the frangible portion releasable when loaded to a predetermined loading limit.
Clause 2: The track system of clause 1, wherein the elongatable and contractable portion is configured as two slidingly engaged components and comprise a tubular portion affixed to the track frame and a tie rod attached to the vehicle frame, the tie rod extending into the tubular portion.
Clause 3: The track system of clause 2, wherein the frangible portion is a shear bolt or pin extending through the tubular portion and tie rod.
Clause 4: The track system of clause 1, wherein the elongatable and contractable portion comprises a tubular portion and a shaft within the tubular portion, and the frangible portion is a shear pin extending through an aperture in the shaft and apertures in the tubular portion.
Clause 5: The track system of clause 4, wherein upon the shear pin breaking, the shaft can travel between a first stop and a second stop.
Clause 6: The track system of clause 4, wherein a limiter strap has a first end attached to the vehicle frame and a second end attached to the tubular portion, such that the limiter strap keeps the shaft in proximity to the tubular portion upon shearing of the shear pin.
Clause 7: The track system of clause 1, wherein the vehicle is a UTV.
Clause 8: The track system of any of the above clauses, wherein the frangible portion is located at a juncture.
Clause 9: The track system of any of the above clauses, wherein when the frangible portion releases, and audible signal is produced.
Clause 10: The track system of any of the above clauses, further having a plurality of frangible portions, including a plurality of spare frangible portions.
Clause 11: An overload protection system for a tracked vehicle, the system having: an anti-rotation device providing a breakable link between the vehicle frame and the wheel-based track system, the breakable link configured to fail before damage to the vehicle frame or track system when the vehicle traverses an obstacle.
Clause 12: An overload protection system for a tracked vehicle, the tracked vehicle has a plurality of track systems, the overload protection system having a respective anti-rotation device for connection between a track frame of each track systems and the vehicle suspension, each anti-rotation system providing rotation resistance of the track system with respect to the vehicle when the track system encounters a change of terrain and/or obstacle, the anti-rotation device having an elongatable and contractable portion, a progressive resistance portion attached to the elongatable and contractable portion, and a releasable portion that releases when the anti-rotation device is subjected to a predetermined excessive loading, the release effecting a transition of the track system from a full functioning mode to a lesser functioning mode.
Clause 13: The overload protection system of clause 12, wherein the releasable portion is resettable by an operator of the vehicle or is self-resettable.
Clause 14: The overload protection system of clause 13, wherein the releasable portion is a fracturable component and the resetting comprises replacing the fracturable component.
Clause 15: The overload protection system of clause 13, wherein the releasable portion is a detent mechanism.
Clause 16: Any of the track systems or overload protection systems of clauses 1-5, in combination with a UTV, the track system and overload protection system mounted on the UTV.
Clause 17: A track system for attachment to a hub assembly of a vehicle, wherein the vehicle has the hub assembly with a hub having an axis of rotation, the hub assembly supported by a suspension system, the track system having: a track frame supporting a drive sprocket and a plurality of idler wheels, a looped track supported by the drive sprocket and a plurality of idler wheels, the drive sprocket attachable to the hub, the track frame, the plurality of idler wheels rotatable about the hub axis of rotation when the drive sprocket is installed on the hub; and an anti-rotation device for connecting the track frame to the vehicle frame, the anti-rotation device having an at rest normal length and being elongatable and contractable, the anti-rotation device having: an elongatable and contractable portion having two components slidingly engaged, the elongatable and contractable portion connected to the track frame and connectable to the suspension system of the vehicle, the elongatable and contractable portion having a first maximum extension length;
an elongate spring configured to compress or extend under elongation and/or contraction of the elongatable and contractable portion; and a releasable portion configured to release in a predetermined overload condition that then provides a second maximum extension length of the elongatable and extension portion.
Clause 18: The track system of clause 17, wherein the releasable portion comprises a sacrificial member that is replaceable and when the elongatable and contractable portion to the first maximum extension length.
Clause 19: The track system of clause 17, wherein the releasable portion comprises a detent mechanism.
Clause 20: The track system of clause 19, wherein the detent system is adjustable for varying the loading level at which point the releasable portion releases.
Clause 21: The track system of clause 17, wherein the releasable portion is a cam mechanism.
Clause 22: The track system of any of clauses 17-21, further having a strap or linkage to limit the maximum separation of the track frame and suspension.
Clause 23: The track system of clause 17, wherein the strap or linkage is connected to the anti-rotation device or the track frame at an attachment region of the anti-rotation device and the track frame and is further connected to the suspension.
Clause 24: The track system of any of clauses 19-23, and wherein the releaseable portion is self-resetting.
Clause 25: An assemblage of components for retail sale, the assemblage having: one or more track systems; an anti-rotation device for each track system, each anti-rotation device having an releasable portion for overload conditions; instructions for installing the track systems; packaging containing the above.
Clause 26: The assemblage of clause 25, wherein the releasable portion comprises a sacrificial component that fractures or changes condition upon overload conditions, and wherein the assemblage comprises a plurality of spare sacrificial components.
Clause 27: The assemblage of clauses 25 or 26, further having bracketing for attachment of each anti-rotation device to the suspension of the vehicle on which the tracks are installed.
Clause 28: The assemblage of clauses 25 or 26, further having a replacement control arm for attachment of the anti-rotation device for each track system.
Clause 29: The assemblage of any of clauses 25-28, further having limiting straps for limiting steering.
Clause 30: The assemblage of any of clauses 25-29, further having one or more retention straps for limiting the separation of components of the anti-rotation device when the releasable portion releases.
Clause 31: The assemblage of any of claims 25-30, further having one or more retention straps for limiting rotation of the track system when the releasable portion releases.
Clause 32: An assemblage of a replacement anti-rotation device for a tracked vehicle, the assemblage having: one or more anti-rotation devices having a releasable portion for when the track system to which the anti-rotation device experiences an overload condition; retention straps or devices to limit the separation of components when the track system to which the anti-rotation device is attached releases.
Clause 33: A retail assemblage of any combination of the track systems, anti-rotation devices, components, and accessories described herein, further including packaging and instructions, the instructions provided in a tangible, non-transitory medium.
Clause 34: A method for protecting the chassis and/or suspension of a tracked vehicle including, providing a track system with a frame; securing the frame of the track system to the vehicle suspension with a link that is subjected to loading when the track system with a frame rotates about an axis of a drive hub to which it is attached, the link configured to fail when a load on the link exceeds a predetermined threshold.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A track system for attachment to a hub assembly of a vehicle, wherein the vehicle has the hub assembly with a hub having an axis of rotation, the hub assembly supported by a suspension system, the track system comprising:
a track frame supporting a drive sprocket and a plurality of idler wheels, a looped track supported by the drive sprocket and the plurality of idler wheels, the drive sprocket attachable to the hub, the track frame, the plurality of idler wheels rotatable about the axis of rotation when the drive sprocket is installed on the hub;
an anti-rotation device for connecting the track frame to the vehicle frame, the anti-rotation device having an at rest normal length and being elongatable and/or contractable, the anti-rotation device comprising:
an elongatable and contractable portion having two components slidingly engaged, the elongatable and contractable portion connected to the track frame and connectable to the suspension system of the vehicle;
an elongate spring configured to compress or extend under elongation and/or contraction of the elongatable and contractable portion; and
a frangible portion on the elongatable and contractable portion, the frangible portion securing the elongatable and contractable portion, the frangible portion releasable when loaded to a predetermined loading limit.

2. The track system of claim 1, wherein the elongatable and contractable portion is configured as two slidingly engaged components and comprise a tubular portion affixed to the track frame and a tie rod attached to the vehicle frame, the tie rod extending into the tubular portion.

3. The track system of claim 2, wherein the frangible portion is a shear bolt or pin extending through the tubular portion and the tie rod.

4. The track system of claim 1, wherein the elongatable and contractable portion comprises a tubular portion and a shaft within the tubular portion, and the frangible portion is a shear pin extending through an aperture in the shaft and apertures in the tubular portion.

5. The track system of claim 4, wherein upon the shear pin breaking, the shaft can travel between a first stop and a second stop.

6. The track system of claim 4, wherein a limiter strap has a first end attached to the vehicle frame and a second end attached to the tubular portion, such that the limiter strap keeps the shaft in proximity to the tubular portion upon shearing of the shear pin.

7. The track system of claim 1, wherein the vehicle is a UTV.

8. The track system of claim 1, wherein the frangible portion is located at a juncture.

9. The track system of claim 1, wherein when the frangible portion releases and audible signal is produced.

10. The track system of claim 1, further comprising a plurality of frangible portions, including a plurality of spare frangible portions.

11. The track system of claim 1, wherein the anti-rotation device comprises a breakable link between the vehicle frame and a wheel-based track system, the breakable link configured to fail before damage to the vehicle frame or track system when the vehicle traverses an obstacle.

12. An overload protection system for a tracked vehicle, the tracked vehicle have a plurality of track systems, the overload protection system comprising a respective anti-rotation device for connection between a track frame of each track system and the vehicle suspension, each anti-rotation system providing rotation resistance of the track system with respect to the vehicle when the track system encounters a change of terrain and/or obstacle, the anti-rotation device comprising an elongatable and contractable portion, a progressive resistance portion attached to the elongatable and contractable portion, and a releasable portion that releases when the anti-rotation device is subjected to a predetermined excessive loading, a release of the releasable portion effecting a transition of the track system from a full functioning mode to a lesser functioning mode.

13. The overload protection system of claim 12, wherein the releasable portion is resettable by an operator of the vehicle or is self-resettable.

14. The overload protection system of claim 13, wherein the releasable portion is a fracturable component and the resetting comprises replacing the fracturable component.

15. The overload protection system of claim 13, wherein the releasable portion is a detent mechanism.

16. The overload protection system of claim 12, in combination with a UTV, the track system and the overload protection system mounted on the UTV.

17. A track system for attachment to a hub assembly of a vehicle, wherein the vehicle has the hub assembly with a hub having an axis of rotation, the hub assembly supported by a suspension system, the track system comprising:
a track frame supporting a drive sprocket and a plurality of idler wheels, a looped track supported by the drive sprocket and the plurality of idler wheels, the drive sprocket attachable to the hub, the track frame, the plurality of idler wheels rotatable about the axis of rotation when the drive sprocket is installed on the hub;
an anti-rotation device for connecting the track frame to the vehicle frame, the anti-rotation device having an at rest normal length and being elongatable and contractable, the anti-rotation device comprising:
an elongatable and contractable portion having two components slidingly engaged, the elongatable and contractable portion connected to the track frame and connectable to the suspension system of the vehicle, the elongatable and contractable portion having a first maximum extension length;
an elongate spring configured to compress or extend under elongation and/or contraction of the elongatable and contractable portion; and
a releasable portion configured to release in a predetermined overload condition that then provides a second maximum extension length of the elongatable and extension portion.

18. The track system of claim 17, wherein the releasable portion comprises a sacrificial member that is replaceable and when the elongatable and contractable portion to the first maximum extension length.

19. The track system of claim 17, wherein the releasable portion comprises a detent mechanism.

20. The track system of claim 19, where in the detent mechanism is adjustable for varying a loading level at which point the releasable portion releases.

21. The track system of claim 17, wherein the releasable portion is a cam mechanism.

22. The track system of claim 17, further comprising a strap or linkage to limit a maximum separation of the track frame and suspension.

23. The track system of claim 22, wherein the strap or linkage is connected to the anti-rotation device or the track frame at an attachment region of the anti-rotation device and the track frame and is further connected to the suspension.

24. The track system of claim 17, and wherein the releasable portion is self-resetting.

25. An assemblage of components for retail sale, the assemblage comprising:
one or more track systems;
an anti-rotation device for each track system, each anti-rotation device having an releasable portion for overload conditions;
instructions for installing the one or more track systems; and
packaging containing the above.

26. The assemblage of claim 25, wherein the releasable portion comprises a sacrificial component that fractures or changes condition upon overload conditions, and wherein the assemblage comprises a plurality of spare sacrificial components.

27. The assemblage of claim 25, further comprising bracketing for attachment of each anti-rotation device to a suspension of the vehicle on which the one or more track systems are installed.

28. The assemblage of claim 25, further comprising a replacement control arm for attachment of the anti-rotation device for each track system.

29. The assemblage of claim 25, further comprising limiting straps for limiting steering.

30. The assemblage of claim 25, further comprising one or more retention straps for limiting a separation of components of the anti-rotation device when the releasable portion releases.

31. The assemblage of claim 25, further comprising one or more retention straps for limiting rotation of the track system when the releasable portion releasees.

32. An assemblage of a replacement anti-rotation device for a tracked vehicle, the assemblage comprising:
one or more anti-rotation devices having a releasable portion for when the track system to which the anti-rotation device experiences an overload condition; and
retention straps or devices to limit a separation of components when the track system to which the anti-rotation device is attached releases.

33. The assemblage of claim 32, further comprising packaging and instructions.

34. A method for protecting at least one of a chassis, a suspension, or a combination of the chassis and the suspension of a tracked vehicle, comprising:
providing a track system with a frame; and
securing the frame of the track system to the vehicle suspension with a link that is subjected to loading when the track system with the frame rotates about an axis of a drive hub to which it is attached, the link configured to fail when a load on the link exceeds a predetermined threshold.
